(19) United States
(12) Patent Application Publication
(10) Pub. No.: US 2015/0072615 A1
(43) Pub. Date: Mar. 12, 2015

(54) SYSTEMS AND METHODS FOR REDUCING TRANSMISSION INTERFERENCE WITH A PARASITIC LOOP

(71) Applicant: QUALCOMM Incorporated, San Diego, CA (US)

(72) Inventors: Mahbod Mofidi, San Diego, CA (US); Thomas P. Cargill, San Diego, CA (US)

(21) Appl. No.: 14/448,795

(22) Filed: Jul. 31, 2014

Related U.S. Application Data
(60) Provisional application No. 61/874,973, filed on Sep. 6, 2013.

(51) Int. Cl. H04B 1/12; H04B 5/00

(52) U.S. Cl. CPC H04B 1/12; H04B 5/0075
USPC 455/41.1; 455/193.1

(57) ABSTRACT

A method for reducing transmission interference is described. The method may be performed by a wireless communication device. The method includes determining that a tuned FM frequency of an FM receiver is within a threshold of a harmonic of an inductive communication transmission produced by an inductive communication transceiver. A magnetic field of the inductive communication transceiver is inductively coupled with the FM receiver. The method also includes canceling the harmonic of the inductive communication transmission by energizing a parasitic loop with the magnetic field.

### RELATED APPLICATIONS

This application is related to and claims priority from U.S. Provisional Patent Application Ser. No. 61/874,973, filed Sep. 6, 2013, for “Method for Mitigating NFC Radio Interference on FM Radios Using Parasitic Loops.”

### TECHNICAL FIELD

The present disclosure relates generally to signal processing. More specifically, the present disclosure relates to systems and methods for reducing transmission interference with a parasitic loop.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Many electronic devices may make use of multiple different technologies. For example, a cell phone may include an FM receiver in addition to transceivers for other communication technologies. These technologies may experience interference when used concurrently. For example, an FM receiver may experience desensitization during concurrent use with a near field communication (NFC) radio. Benefits may be realized by reducing the interference between technologies.

### SUMMARY

A method for reducing transmission interference is descripted. The method includes determining that a tuned FM frequency of an FM receiver is within a threshold of a harmonic of an inductive communication transmission produced by an inductive communication transceiver. A magnetic field of the inductive communication transceiver is inductively coupled with the FM receiver. The method also includes canceling the harmonic of the inductive communication transmission by energizing a parasitic loop with the magnetic field.

The parasitic loop may be tuned to be an electrical short at the frequency of the harmonic. The parasitic loop tuning may be fixed based on an FM band of a country of deployment. The method may also include tuning the parasitic loop to the tuned FM frequency during operation of the FM receiver. The parasitic loop may also be tuned to provide wideband cancelation of multiple harmonics.

Tuning the parasitic loop may include adjusting one or more tunable capacitors coupled to the parasitic loop. Tuning the parasitic loop may include adding or subtracting inductors or capacitors to a closed circuit of the parasitic loop.

The parasitic loop may include a coil and a shunt series circuit. The shunt series circuit may allow for tuning of the parasitic loop. The parasitic loop may be located near an inductive communication antenna to ensure strong inductive coupling between the inductive communication antenna and the parasitic loop.

The method may also include activating the parasitic loop when the tuned FM frequency is within the threshold of the harmonic. When the parasitic loop is activated, a null in a magnetic field of the inductive communication antenna may be created at the frequency of the parasitic loop. When the parasitic loop is activated, there may be a short at the harmonic and an open circuit at an operating frequency of an inductive communication transceiver.

The tuned FM frequency of the FM receiver may be proactively shared by the FM receiver. The tuned FM frequency of the FM receiver may be requested from the FM receiver by a subsystem controlling the parasitic loop.

The inductive communication transmission may be produced by a near-field communication (NFC) transceiver. The parasitic loop may be used as a secondary NFC antenna when not needed to reduce FM interference.

The parasitic loop may be utilized as a transmitting or a receiving antenna during active load modulation. The parasitic loop may be placed over an inductive communication antenna to control the direction of an H-field of the inductive communication antenna.

An apparatus for reducing transmission interference is also described. The apparatus includes a processor, memory in electronic communication with the processor and instructions stored in the memory being executable by the processor. The apparatus determines that a tuned FM frequency of an FM receiver is within a threshold of a harmonic of an inductive communication transmission produced by an inductive communication transceiver. A magnetic field of the inductive communication transceiver is inductively coupled with the FM receiver. The apparatus also cancels the harmonic of the inductive communication transmission by energizing a parasitic loop with the magnetic field.

A wireless communication device for reducing transmission interference is also described. The wireless communication device includes means for determining that a tuned FM frequency of an FM receiver is within a threshold of a harmonic of an inductive communication transmission produced by an inductive communication transceiver. A magnetic field of the inductive communication transceiver is inductively coupled with the FM receiver. The wireless communication device also means for canceling the harmonic of the inductive communication transmission by energizing a parasitic loop with the magnetic field.

### BRIEF DESCRIPTION OF THE DRAWINGS

FIG. 1 is a block diagram illustrating one configuration of a wireless communication device in which systems and methods for reducing transmission interference may be implemented;

FIG. 2 is a flow diagram illustrating one configuration of a method for reducing transmission interference with a parasitic loop;

FIG. 3 is a block diagram illustrating another configuration of a wireless communication device in which systems and methods for reducing transmission interference may be implemented;

FIG. 4 is a layout of one configuration of a parasitic loop and an NFC loop antenna;

FIG. 5 illustrates one configuration of a parasitic loop;

FIG. 6 is a circuit diagram illustrating one configuration of a programmable circuit for a parasitic loop;

FIG. 7 is a flow diagram of a method for reducing NFC radio interference on FM radios; and

FIG. 8 illustrates certain components that may be included within a wireless communication device.

### DETAILED DESCRIPTION

The systems and methods disclosed herein may be applied to communication devices that communicate wirelessly and/or that communicate using a wired connection or link. It should be noted that some communication devices may communicate wirelessly and/or may communicate using a wired connection or link. For example, some communication devices may communicate with other devices using an Ethernet protocol. In one configuration, the systems and methods disclosed herein may be applied to a communication device that communicates with another device using an inductive communication technology. One implementation of an inductive communication technology is near-field communication (NFC).

The rise of NFC technology and increased user demand for enhanced FM broadcast receiver (Rx) performance in electronic devices (e.g., mobile devices) has created a potential challenge for concurrency. As used herein, the term “concurrency” refers to the simultaneous (e.g., concurrent) operation of an FM receiver and an inductive communication transceiver on an electronic device. In some scenarios, one or more harmonics of a transmission by the inductive communication technology may fall within an FM broadcast band (e.g., 76-108 megahertz (MHz)). These harmonics may interfere with (also referred to herein as desense or desensitize) an FM channel and may potentially interfere with adjacent FM channels.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

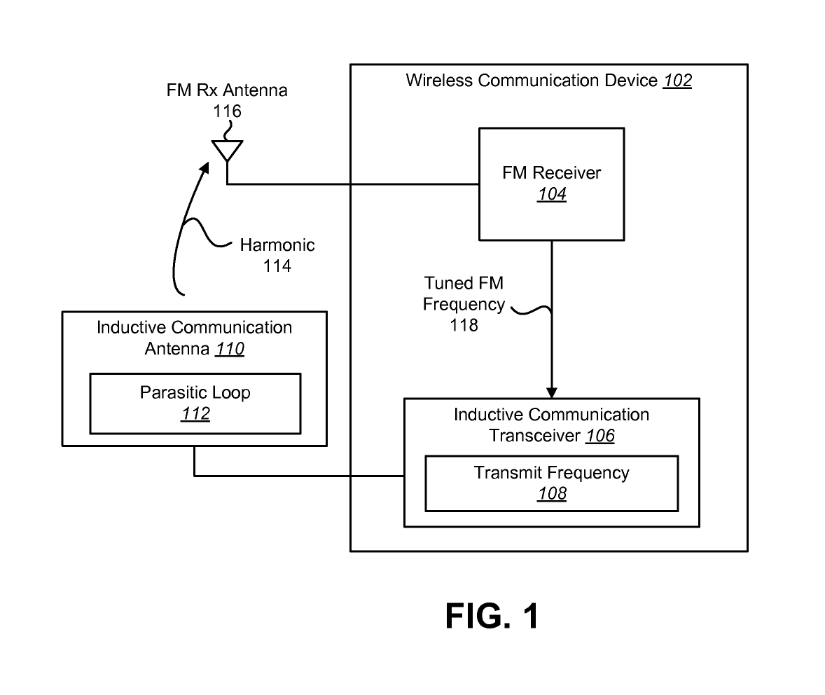

FIG. 1 is a block diagram illustrating one configuration of a wireless communication device 102 in which systems and methods for reducing transmission interference may be implemented. Wireless communication systems are widely deployed to provide various types of communication content such as voice, data, and so on. A wireless communication device 102 may utilize multiple communication technologies that may operate simultaneously (e.g., concurrently). For example, a wireless communication device 102 may include an FM receiver 104 that may receive an FM broadcast. The wireless communication device 102 may also include an inductive communication transceiver 106 that may transmit and receive inductive signals.

Communications in a wireless system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

A wireless communication system may utilize MIMO. A MIMO system may support both time division duplex (TDD) and frequency division duplex (FDD) systems. In a TDD system, uplink and downlink transmissions are on the same frequency region so that the reciprocity principle allows the estimation of the downlink channel from the uplink channel. This enables a transmitting wireless device (e.g., wireless communication device 102) to extract transmit beamforming gain from communications received by the transmitting wireless device.

A wireless communication system may be a multiple-access system capable of supporting communication with multiple wireless communication devices 102 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems, and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems, and mobile devices.

In 3GPP Long Term Evolution (LTE) and UMTS, a wireless communication device 102 may be referred to as a “user equipment” (UE). In 3GPP Global System for Mobile Communications (GSM), a wireless communication device 102 may be referred to as a “mobile station” (MS). A wireless communication device 102 may also be referred to as, and may include some or all of the functionality of, a terminal, an access terminal, a subscriber unit, a station, etc. A wireless communication device 102 may be a cellular phone, a personal digital assistant (PDA), a wireless device, a wireless modem, a handheld device, a laptop computer, a Session Initiation Protocol (SIP) phone, a wireless local loop (WLL) station, etc.

The wireless communication device 102 may include an FM receiver 104, which may receive an FM broadcast via an FM Rx antenna 116. In one configuration, the FM Rx antenna 116 may reside in a wired headset connected to the wireless communication device 102. The FM receiver 104 may tune the FM Rx antenna 116 to a desired FM frequency (e.g., tuned FM frequency 118) within the FM spectrum and then receive the tuned FM station. FM broadcasting may vary according to country. For example, in the USA, FM radio stations broadcast at frequencies of 87.8 to 108 MHz. In Japan, FM radio stations broadcast at frequencies of 76-90 MHz.

The wireless communication device 102 may include an inductive communication transceiver 106, which may establish radio communication with another wireless communication device 102 (e.g., a target) using magnetic induction. In one configuration, the inductive communication transceiver 106 may be a near-field communication (NFC) transceiver that operates according to NFC protocols. The inductive communication transceiver 106 may include an inductive transmitter and a receiver.

The inductive communication transceiver 106 may transmit a signal to another wireless communication device 102 via an inductive communication antenna 110. One or more harmonics 114 may be generated from the transmission of the signal. A harmonic 114 may also be referred to as a spurious emission or spur. A harmonic 114 may be a multiple of a given transmit frequency 108. For example, if the transmit frequency 108 is 13.56 megahertz (MHz), the sixth harmonic of the transmit frequency 108 is 6×13.56 MHz or 81.36 MHz. A harmonic 114 may fall in the FM broadcast band (e.g., 76-108 MHz). A harmonic 114 may be received by the FM Rx antenna 116 and may potentially interfere with (e.g., desense) one or more FM channels.

A parasitic loop 112 may reduce interference from a harmonic 114 of an inductive communication transmission. The parasitic loop 112 may protect the FM receiver 104 from interference caused by a transmission of the inductive communication transceiver 106 at specific frequencies. The parasitic loop 112 may be of similar size as the inductive communication antenna 110. The parasitic loop 112 may be placed close to the inductive communication antenna 110 (e.g., on top of the coil of an inductive communication antenna 110) and tuned to cancel one or more harmonics 114 of the inductive communication transmission. For example, if the FM receiver 104 is tuned to the 94.9 FM channel, the parasitic loop 112 may be tuned to prevent the inductive communication antenna 110 from broadcasting at the 7th harmonic of the NFC transmit frequency 108 (i.e., 94.92 MHz).

By Lenz's law, a parasitic coil tuned to be an electrical short at the frequency of interest located within the vicinity of a coil that is excited by an external magnetic field will generate an opposing magnetic field due to an induced current. As a result, the shorted parasitic coil will create a null in the magnetic field over the shorted parasitic coil. This creates a wideband effect that cancels the magnetic field for one or more frequencies of interest. As used herein, the terms “cancel” or “canceling” refer to reducing a signal. Therefore “canceling the magnetic field” refers to reducing the magnetic field. Canceling may occur when the parasitic loop 112 is energized by the magnetic field of the inductive communication antenna 110. It should be noted that canceling a signal may or may not result in a complete elimination of the signal.

The parasitic loop 112 may include a shorted parasitic coil. In one configuration, the parasitic loop 112 may include a coil and a shunt series circuit. The coil may be of similar size as the coil of the inductive communication antenna 110 so that coupling between the parasitic coil and the coil of the inductive communication antenna 110 is strong. The coil may be coupled to a shunt series circuit that allows the parasitic loop 112 to be tuned to specific frequencies.

By placing the parasitic loop 112 near the inductive communication antenna 110 and then tuning the parasitic loop 112 to a specific frequency, the parasitic loop 112 will create a null in the magnetic field of the inductive communication antenna 110 for the desired frequency. If the parasitic loop 112 is tuned to the harmonic 114 of the transmit frequency 108, a null in a magnetic field of the inductive communication antenna 110 is created at the harmonic 114. In other words, when the inductive communication antenna 110 is transmitting near the parasitic loop 112, there is a short at the harmonic 114 frequency but an open circuit at the inductive communication operating frequency (e.g., letting the transmit frequency 108 pass but notching out the harmonic 114 frequency).

The parasitic loop 112 may cancel the harmonic 114 of the inductive communication transmission by tuning the parasitic loop 112 based on a tuned FM frequency 118. The harmonic 114 may be canceled by energizing the parasitic loop 112 by the magnetic field of an inductive communication antenna 110. The parasitic loop 112 may be tuned to be an electrical short at the frequency of the harmonic 114 when the tuned FM frequency 118 is within a threshold of the harmonic 114.

In one configuration, the parasitic loop 112 tuning may be fixed based on the FM band of a country of deployment. The parasitic loop 112 may be tuned based on the one or more harmonics 114 that may interfere with a tuned FM frequency 118 used in the country or region in which the wireless communication device 102 is operating. For example, if it is determined that a tuned FM frequency 118 within the FM band of the country of deployment will be interfered (e.g., desensed) by the sixth harmonic 114 of the transmit frequency 108, then the parasitic loop 112 may be tuned to cancel the sixth harmonic 114. In one implementation, the parasitic loop 112 tuning may be performed statically during the manufacture of the wireless communication device 102. In another implementation, this parasitic loop 112 tuning may be based on a signal indicating the country of deployment.

In another configuration, the parasitic loop 112 may be tunable during operation of the FM receiver 104. In this configuration, the parasitic loop 112 may be tuned to a current or future tuned FM frequency 118 during operation of the wireless communication device 102. By tuning the parasitic loop 112 during operation, a notch frequency may be created to cancel a harmonic 114 of the transmit frequency 108.

The wireless communication device 102 may determine that the tuned FM frequency 118 of the FM receiver 104 is within a threshold of a harmonic 114 of an inductive communication transmission during operation. In other words, the wireless communication device 102 may determine that the tuned FM frequency 118 of the FM receiver 104 is within a certain frequency range of a harmonic 114 of the inductive communication transmission. If the tuned FM frequency 118 is within the threshold of a harmonic 114, the wireless communication device 102 may tune the parasitic loop 112 to cancel the harmonic 114.

In order to select the desired notch frequency closest to the current FM operating frequency (e.g., the tuned FM frequency 118), a programmable circuit may be used to tune the parasitic loop 112. The programmable circuit may tune the parasitic loop 112 based on the tuned FM frequency 118. In one configuration, the programmable circuit may include one or more adjustable capacitors coupled to the parasitic loop 112 that may be adjusted to tune the parasitic loop 112 to the tuned FM frequency 118. In another configuration, the programmable circuit may include one or more switches that add or subtract inductors and/or capacitors to a closed circuit of the parasitic loop 112 to tune the parasitic loop 112 to the tuned FM frequency 118.

Control of the programmable circuit configuration may be based on one or more control signals. In one configuration, a control signal may come from a local inductive communication transceiver 106 controller. In another configuration, the control signal may be received from any other system on the wireless communication device 102 with knowledge of the current or future tuned FM frequency 118. The tuned FM frequency 118 may be shared (proactively) by the FM receiver 104 through a host (e.g., application processor) and host interfaces or shared (proactively) over a direct link between the FM subsystem and the subsystem controlling the parasitic loop 112. The tuned FM frequency 118 may also be requested from the FM receiver 104.

Because the FM receiver 104 can switch to a different frequency, the wireless communication device 102 may dynamically tune the parasitic loop 112. In other words, the wireless communication device 102 may dynamically control the frequency of the parasitic loop 112 based on the tuned FM frequency 118.

If the FM receiver 104 is controlling the notch frequency of the parasitic loop 112, there may be additional desensitization through this connection (which resides over the inductive communication antenna 110). Thus, the tuning of parasitic loop 112 may be fixed (with the component values changed based on the country of deployment, as described above).

In another configuration, the parasitic loop 112 may be activated and deactivated for canceling a harmonic 114 of the inductive communication transmission. The programmable circuit may activate the parasitic loop 112 when the tuned FM frequency 118 is within the threshold of a harmonic 114. The parasitic loop 112 may be tuned to the tuned FM frequency 118. When the parasitic loop 112 is activated for canceling the harmonic 114, a null in the magnetic field of the inductive communication antenna 110 is created at the tuned frequency of the parasitic loop 112. Therefore, when the parasitic loop 112 is activated, there is a short at the harmonic 114 and an open circuit at an operating frequency (e.g., transmit frequency 108) of the inductive communication transmitter.

When the tuned FM frequency 118 is not within the threshold of the harmonic 114, the parasitic loop 112 may be deactivated for use in canceling a harmonic 114 of the inductive communication transmission. In one configuration, the parasitic loop may be used as a secondary NFC antenna when not needed to reduce FM interference.

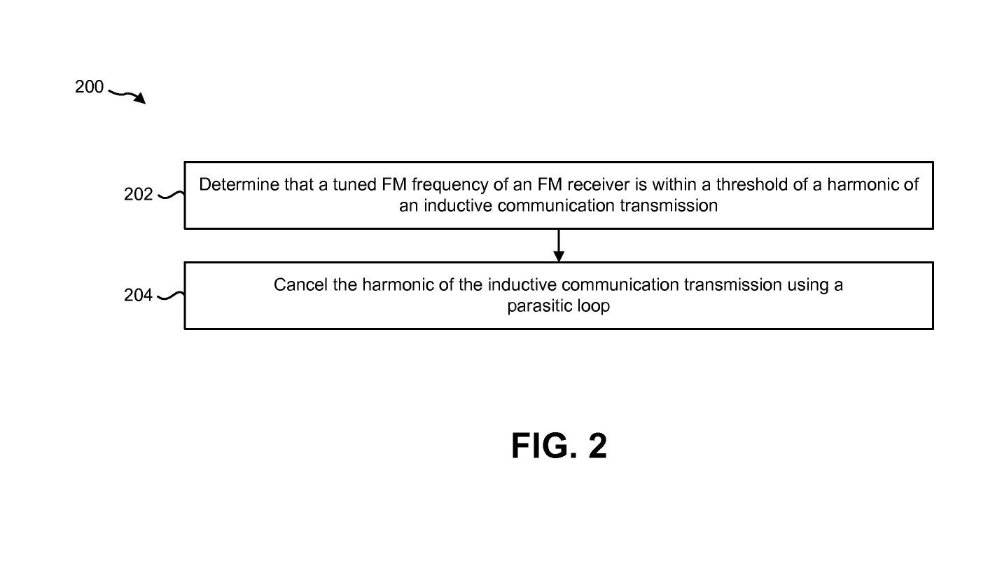

FIG. 2 is a flow diagram illustrating one configuration of a method 200 for reducing transmission interference with a parasitic loop 112. In one implementation, a wireless communication device 102 may perform the method 200 illustrated in FIG. 2 in order to mitigate FM desensitization by NFC.

The wireless communication device 102 may determine 202 that a tuned FM frequency 118 of an FM receiver 104 is within a threshold of a harmonic 114 of an inductive communication transmission. The wireless communication device 102 may receive an FM broadcast. The FM receiver 104 of the wireless communication device 102 may be tuned to an FM frequency (e.g., a tuned FM frequency 118) that is in the FM broadcast band (e.g., 76-108 MHz).

A magnetic field of the inductive communication transmission may be inductively coupled with the FM receiver 104. The inductive communication transmission may be produced by an inductive communication transceiver 106. The FM receiver 104 may receive one or more harmonics 114 associated with a transmit frequency 108 of the inductive communication transceiver 106. A harmonic 114 may fall within the bandwidth of the tuned FM frequency 118, which may interfere with the FM channel.

The tuned FM frequency 118 may be compared to the harmonic 114 of the transmit frequency 108. The wireless communication device 102 may determine 202 that the tuned FM frequency 118 is within a threshold of the harmonic 114.

The wireless communication device 102 may cancel 204 the harmonic 114 of the inductive communication transmission using a parasitic loop 112. The parasitic loop 112 may be of similar size as an antenna 110 of inductive communication transceiver 106. The parasitic loop 112 may be located close to the inductive communication antenna 110 (e.g., on top of the coil of an inductive communication antenna 110). The size and location of the parasitic loop 112 may provide a strong magnetic coupling between the parasitic loop 112 and the inductive communication antenna 110.

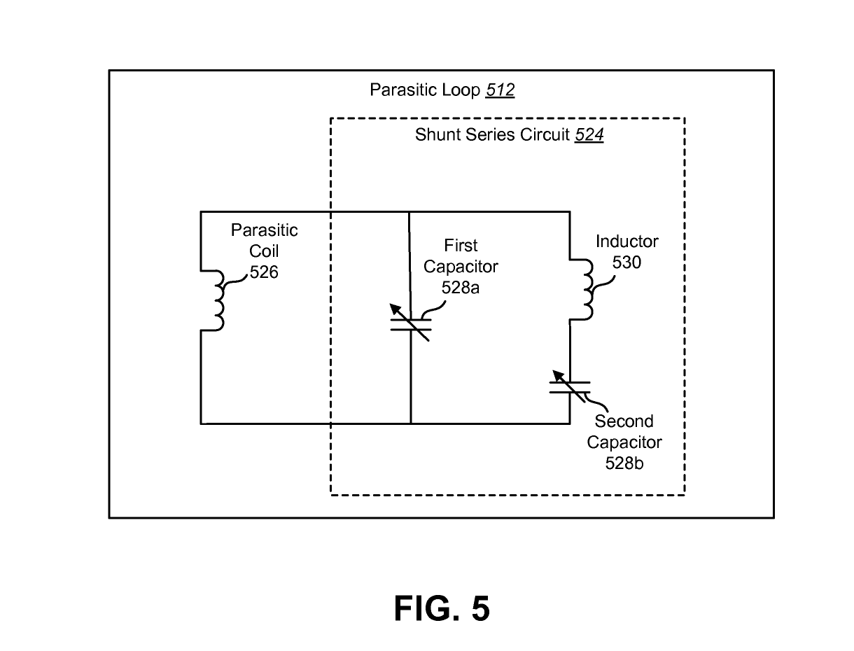

The parasitic loop 112 may include a coil and a programmable circuit. The programmable circuit may be used to tune the parasitic loop 112 based on the tuned FM frequency 118. In one configuration, the programmable circuit may include one or more adjustable capacitors coupled to the parasitic loop 112 that may be adjusted to tune the parasitic loop 112 to the tuned FM frequency 118. In another configuration, the programmable circuit may include one or more switches that add or subtract inductors and/or capacitors to a closed circuit of the parasitic loop 112 to tune the parasitic loop 112 to the tuned FM frequency 118. The programmable circuit may be a shunt series circuit as described in connection with FIG. 5.

In one configuration, the parasitic loop 112 tuning may be fixed based on the FM band of a country of deployment. For example, the parasitic loop 112 may be tuned based on which harmonic(s) 114 of the inductive communication transmit frequency 108 may interfere with a tuned FM frequency 118 used in the country or region in which the wireless communication device 102 is operating. In one implementation, this tuning may be performed statically during the manufacture of the wireless communication device 102. In another implementation, this tuning may be based on a signal indicating the country of deployment.

In another configuration, the parasitic loop 112 may be tunable during operation. In this configuration, the parasitic loop 112 may be tuned to the tuned FM frequency 118 during operation of the wireless communication device 102. By tuning the parasitic loop 112 during operation, a notch frequency may be created to cancel 204 a harmonic 114 of the transmit frequency 108.

The wireless communication device 102 may tune the parasitic loop 112 based on one or more control signals. For example, when the wireless communication device 102 determines 202 that the tuned FM frequency 118 is within a threshold of a harmonic 114 of an inductive communication transmission, the wireless communication device 102 sends control signals to the programmable circuitry. The control signals may originate from the inductive communication transceiver 106, the FM receiver and/or a host (e.g., application processor).

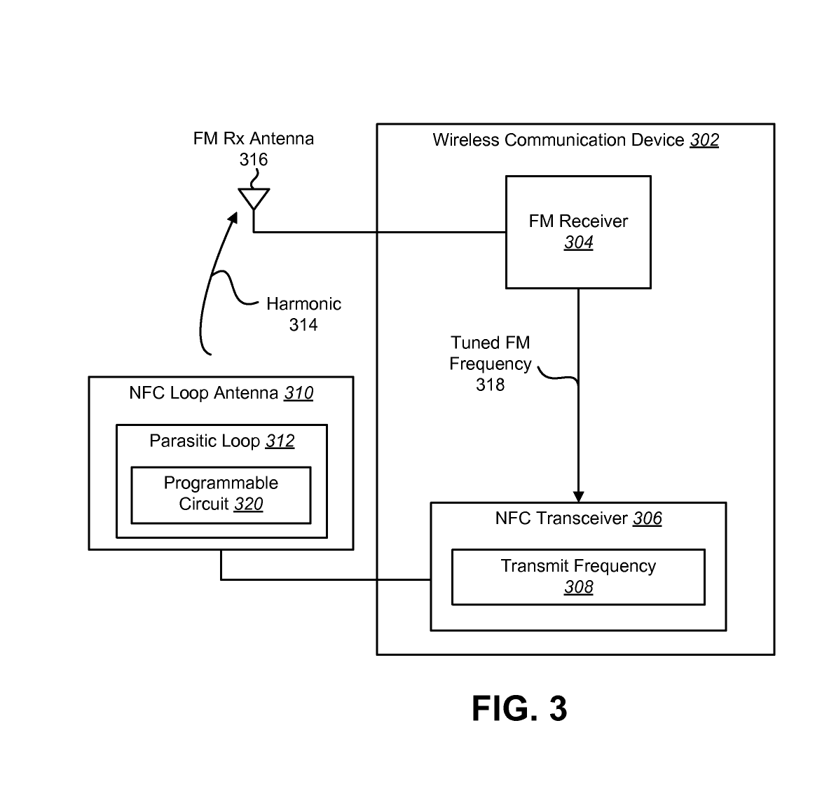

FIG. 3 is a block diagram illustrating another configuration of a wireless communication device 302 in which systems and methods for reducing transmission interference may be implemented. The wireless communication device 302 may include an FM receiver 304 and a near-field communication (NFC) transceiver 306. The FM receiver 304 may receive an FM broadcast via an FM Rx antenna 316. In one configuration, the FM Rx antenna 316 may reside in a wired headset connected to the wireless communication device 302.

The wireless communication device 302 may include an NFC transceiver 306. The NFC transceiver 306 may include an NFC transmitter and an NFC receiver. The NFC transceiver 306 may establish radio communication with another wireless communication device 302 (e.g., a target or NFC target device) using NFC protocols.

NFC is an inductive communication technology. Input power may be provided to an NFC transmitter for generating a radiated field for providing energy transfer. An NFC receiver of another wireless communication device 302 (not shown) may couple to the radiated field and may generate an output power. The two NFC-capable wireless communication devices 302 may be separated by a distance.

In one configuration, the NFC transmitter of one wireless communication device 302 and the NFC receiver of the other wireless communication device 302 are configured according to a mutual resonant relationship. When the resonant frequency of the NFC receiver and the resonant frequency of the NFC transmitter are very close, transmission losses between the NFC transmitter and the NFC receiver are minimal when the NFC receiver is located in the “near-field” of the radiated field.

The wireless communication device 302 may include an NFC loop antenna 310. The NFC loop antenna 310 may provide a means for energy transmission and reception. As stated, an efficient energy transfer may occur by coupling a large portion of the energy in the near-field of a transmitting antenna to a receiving antenna rather than propagating most of the energy in an electromagnetic wave to the far field. When in this near-field, a coupling mode may be developed between NFC loop antennas 310. The area around the NFC loop antennas 310 where this near-field coupling may occur is referred to herein as a coupling-mode region.

An NFC-capable wireless communication device 302 may obtain sufficient information to allow for communications to be established. One form of communications that may be established is an international standards organization data exchange protocol (ISO-DEP) communication link. Communications between the NFC devices may be enabled over a variety of NFC radio frequency (RF) technologies, including but not limited to, NFC-A, NFC-B, etc.

An NFC-capable wireless communication device 302 may recognize an NFC target device and/or an unpowered NFC chip (e.g., NFC tag) when within range of the NFC coverage area of the wireless communication device 302. NFC involves an initiator and a target. The initiator may actively generate the radiated field. The target may be passive and may be powered by the radiated field.

The wireless communication device 302 may operate according to multiple NFC use cases. In one use case, the wireless communication device 302 may act as an initiator where the wireless communication device 302 is actively transmitting. In this case, the wireless communication device 302 is acting like a reader of an NFC tag (e.g., a passive tag). Furthermore, in this case the wireless communication device 302 is generating the radiated field.

In another use case, the wireless communication device 302 is in peer-to-peer mode. In this case, the wireless communication device 302 may be communicating with another NFC peer device. The wireless communication device 302 can act as an initiator generating the radiated field, or the wireless communication device 302 can act as a target that is load modulating the radiated field of the NFC peer device.

In a third use case, the wireless communication device 302 may perform card emulation. In this case, the wireless communication device 302 may take the target role (e.g., passive role). The wireless communication device 302 may not initiate any radiated field. Instead, the wireless communication device 302 may modulate the radiated field of another NFC device.

In one configuration, the NFC transceiver 306 may transmit an NFC signal to another wireless communication device 302 or NFC tag via an NFC loop antenna 310. NFC typically operates at 13.56 MHz. One or more harmonics 314 may be generated from the transmission of the NFC signal. A harmonic 314 may fall in the FM broadcast band (e.g., 76-108 megahertz MHz). For instance, the sixth harmonic (e.g., 6*13.56 MHz=81.36 MHz), the seventh harmonic (e.g., 7*13.56 MHz=94.92 MHz) and the eighth harmonic (e.g., 8*13.56 MHz=108.48 MHz) fall onto the FM broadcast band.

The one or more harmonics 314 may be received by the FM Rx antenna 316 and may interfere with (e.g., desense) one or more FM channels. For example, the sixth harmonic may interfere with the FM band (76-90 MHz) used in Japan, while the seventh and eighth harmonics may interfere with the FM band (87.7-108.0 MHz) used in the United States, Europe and other regions. FM channels may have center frequencies ending in 0.1, 0.3, 0.5, 0.7 and 0.9 MHz. In some countries, FM channels may also have center frequencies ending in 0.0, 0.2, 0.4, 0.6 and 0.8 MHz. An FM channel may be 200 kHz wide. When a harmonic 314 falls on an FM operating frequency and the FM signal is weak (e.g., a weak FM station), then the user of the wireless communication device 302 may hear the impact of the harmonic 314 on the FM channel.

Currently, known solutions allow the FM channel(s) to remain desensed or try to mask the audio degradation by muting FM or playing a system audio tone during an NFC transaction. For example, according to the known approaches, when a wireless communication device 302 detects a tag read (where the wireless communication device 302 is acting either as the tag or as the reader), or if the wireless communication device 302 is in peer-to-peer mode, the wireless communication device 302 may mute the FM and play system tones (e.g., a beeping sound) during an NFC transmission. In other words, the known approaches mask the FM audio during NFC transmissions. These known solutions either limit full concurrency (e.g., simultaneous operation of both FM and NFC) or result in highly degraded FM audio quality and channel efficiency. These problems are especially pronounced in countries with limited FM broadcast stations (e.g. India).

In one scenario, an NFC device may perform a polling operation. For example, an NFC device may periodically check for the presence of other NFC devices and/or NFC tags. The polling period may be programmable, but typically the polling occurs every 300 milliseconds (ms), and the polling may last for 10 to 30 ms at a time. Therefore, an NFC-capable wireless communication device 302 may be continually going out and puncturing the FM audio, which may be heard by the user of the wireless communication device 302. In one configuration, NFC polling may occur when the wireless communication device 302 display is on. In another configuration, NFC polling may occur even when the wireless communication device 302 appears to be asleep. Therefore, even when the display is off, if a user is listening to an FM channel, NFC polling may result in audible FM interference.

The level of FM channel desensitization may vary based on the relative position of an FM Rx antenna 316 (e.g., a wired headset) to an NFC loop antenna 310. The wired headset is where the FM Rx antenna 316 may reside. Furthermore, the level of interference may vary based on the type of NFC transaction. Observations have shown a minimum of 10 decibels (dB) to greater than 50 dB of interference due to an NFC harmonic 314 on an FM channel.

Transmission interference caused by one or more harmonics 314 of an NFC transmission may be reduced with a parasitic loop 312. For example, a parasitic loop 312 may reduce FM interference from a local NFC transmitter acting as an initiator or poller. The parasitic loop 312 may also reduce FM interference when a local NFC enabled wireless communication device 302 is in target mode and a second remote NFC enabled wireless communication device 302 is transmitting as an initiator or poller.

The parasitic loop 312 may include a shorted parasitic coil that creates a null in the magnetic field over the shorted parasitic coil. This may be a wideband effect that cancels the magnetic field for one or more frequencies of interest. In one configuration, the parasitic loop 312 may include a parasitic coil and a shunt series circuit. The parasitic coil may be of similar size as the coil of the NFC loop antenna 310 so that magnetic coupling between the coil and the receiving coil of the NFC card is strong. The parasitic coil may be coupled to the shunt series circuit that allows the parasitic loop 312 to be tuned to cancel specific frequencies.

The parasitic loop 312 may be placed close to the NFC loop antenna 310 (e.g., on top of the coil of an NFC loop antenna 310) and tuned to cancel one or more harmonics 314 of the NFC transmission. By placing the parasitic loop 312 near the NFC loop antenna 310 and then tuning the parasitic loop 312 to a harmonic 314 of the NFC transmit frequency 308, the parasitic loop 312 will create a null in the magnetic field of the NFC loop antenna 310 for the harmonic 314. In other words, when the NFC loop antenna 310 is transmitting near the parasitic loop 312, there is a short at the harmonic 314 frequency but an open circuit at the NFC transmit frequency 308. Therefore, the transmit frequency 308 may pass, but the harmonic 314 frequency may be notched out.

In one configuration, the parasitic loop 312 tuning may be fixed based on the FM band of a country of deployment. For example, the parasitic loop 312 may be tuned based on which harmonic(s) 314 of the NFC transmit frequency 308 may interfere with a tuned FM frequency 318 that may be used in the country or region in which the wireless communication device 302 is operating. For example, if it is determined that a tuned FM frequency 318 will be interfered (e.g., desensed) by the sixth harmonic 314 of the NFC transmit frequency 308 (e.g., 81.36 MHz), then the parasitic loop 312 may be tuned to cancel the sixth harmonic 314. Similarly, if a tuned FM frequency 318 will be interfered by the seventh harmonic 314 (e.g., 94.92 MHz) or eighth harmonic 314 (e.g., 108.48 MHz), then the parasitic loop 312 may be tuned to cancel one or more of these harmonics 314.

In one implementation, this tuning may be performed statically during the manufacture of the wireless communication device 302. In another implementation, this tuning may be based on a signal indicating the country of deployment.

The parasitic loop 312 may be tuned to achieve a wideband cancelation of the harmonics 314 that may interfere with the FM receiver 304. This can be achieved by increasing the number of the poles in order to create an electrical short over a wider bandwidth. Typically, the higher the pole number (i.e., additional matching components) would result in a wider bandwidth. The quality factor (Q) can also be increased by using higher Q matching network components with less loss.

In another configuration, the parasitic loop 312 may be tuned during operation. In this configuration, the parasitic loop 312 may be tuned to a current or future tuned FM frequency 318 during operation of the wireless communication device 302. By tuning the parasitic loop 312 during operation, a notch frequency may be created to cancel a harmonic 314 of the transmit frequency 308.

The wireless communication device 302 may determine that the tuned FM frequency 318 of the FM receiver 304 is within a threshold of a harmonic 314 of an NFC transmission during operation. In other words, the wireless communication device 302 may determine that the tuned FM frequency 318 of the FM receiver 304 is at or near a harmonic 314 of the NFC transmission. If the tuned FM frequency 318 is within a threshold of a harmonic 314, the wireless communication device 302 may tune the parasitic loop 312 to cancel the harmonic 314.

In order to select the desired notch frequency closest to the current FM operating frequency (e.g., the tuned FM frequency 318), a programmable circuit 320 may be used to tune the parasitic loop 312. The programmable circuit 320 may tune the parasitic loop 312 based on the tuned FM frequency 318. In one configuration, the programmable circuit 320 may include one or more adjustable capacitors coupled to the parasitic loop 312 that may be adjusted to tune the parasitic loop 312 to the tuned FM frequency 318. In another configuration, the programmable circuit 320 may include one or more switches that add or subtract inductors and/or capacitors to a closed circuit of the parasitic loop 312 to tune the parasitic loop 312 to the tuned FM frequency 318.

Control of the programmable circuit 320 configuration may be based on a control signal. In one configuration, the control signal may come from a local NFC transceiver 306 controller. In another configuration, the control signal may be received from any other system on the wireless communication device 302 with knowledge of the current or future tuned FM frequency 318. The tuned FM frequency 318 may be shared (proactively) by the FM receiver 304 through a host (e.g., application processor) and host interfaces or shared (proactively) over a direct link between the FM subsystem and the subsystem controlling the parasitic loop 312. Furthermore, the tuned FM frequency 318 of the FM receiver 304 may be requested from the FM receiver 304 by a subsystem controlling the parasitic loop 312.

Because the FM receiver 304 can switch to a different frequency, the wireless communication device 302 may dynamically tune the parasitic loop 312. In other words, the wireless communication device 302 may dynamically adjust the frequency of the parasitic loop 312 based on the tuned FM frequency 318.

The parasitic loop 312 may be manufactured from additional metal placed on top of the NFC loop antenna 310. Therefore, the parasitic loop 312 is essentially an additional antenna. Thus, in one configuration, the cost of including the parasitic loop 312 may be justified by using the parasitic loop 312 as a secondary NFC antenna when not needed to reduce FM interference. This may improve or enhance the magnetic field of NFC. For example, the parasitic loop 312 may operate as an NFC transmit or receive antenna when the FM receiver 304 is not operating on or close to a harmonic 314 of the NFC transmit frequency. In one configuration, the parasitic loop 312 may operate as an NFC receiver while the coil of the NFC loop antenna 310 may be used as a transmitter or interrogator.

As NFC antenna sizes shrink, user experience can be affected by reduced operating volume, range and poor coupling to remote antennas. Using the parasitic loop 312 as a secondary NFC antenna may mitigate these problems. When the current or future tuned FM frequency 318 of the FM receiver 304 is at or near a harmonic 314 of the NFC transmit frequency 308 (e.g., within a threshold of a harmonic 314 of the NFC transmit frequency 308), the parasitic loop 312 may be switched from being a secondary NFC antenna to being a parasitic loop antenna to mitigate the desensitization of the FM signal by the NFC transmission.

In order to increase performance with small antennas, some devices might implement active load modulation. The parasitic loop 312 may be used during active load modulation, either as a transmitting or receiving coil and used as a parasitic loop 312 (to cancel harmonics 314) during FM receiving. Using the principle of active load modulation, data from a passive target can be transmitted back to the wireless communication device 302 acting as an NFC reader. If a target with a resonance frequency equal to the transmission frequency of the reader is placed within the magnetic field of the reader's antenna (e.g., the NFC loop antenna 310), the target will be powered by the magnetic field. When a load resistor is switched on and off at the target, the voltage changes at the reader's antenna due to the impedance change in the target resulting in amplitude modulation at the reader's antenna. If data on a chip controls the timing with which the load resistor is switching, then this data can be sent from the target to the reader.

As described above, the parasitic loop 312 may be used as a secondary NFC antenna when not canceling harmonics 314 during FM receiving. While operating as a secondary NFC antenna, the parasitic loop 312 may implement active load modulation. Usage of the parasitic loop antenna 312 for active load modulation may be to use the parasitic loop antenna 312 as an NFC second antenna. This may include transmitting the active load modulation signal from one antenna while receiving on the other antenna.

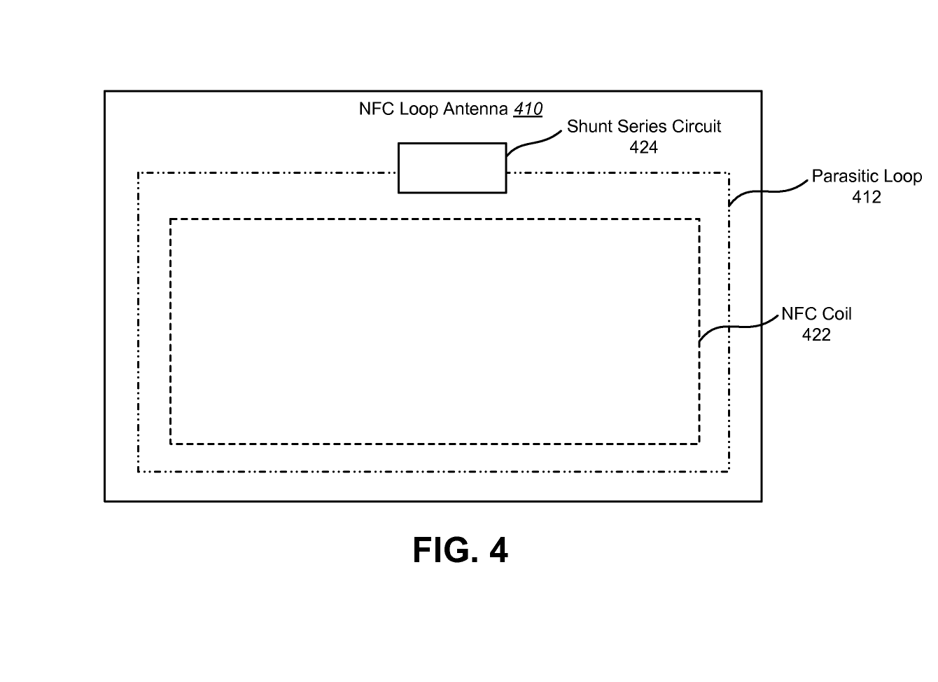

FIG. 4 is a layout of one configuration of a parasitic loop 412 and an NFC loop antenna 410. The NFC loop antenna 410 may include an NFC coil 422. The NFC coil 422 may be a transmitting or receiving coil. The NFC coil 422 may be configured for near-field communication with one or more remote wireless communication devices 102. It is noted that, according to one configuration, the NFC loop antenna 410 may be attached to a surface of a wireless communication device 102 by any suitable means. By way of example, the NFC loop antenna 410 may be integrated within a sticker that may attach to the wireless communication device 102. According to another exemplary configuration, the NFC loop antenna 410 may be integrated within the wireless communication device 102 (e.g., in an NFC transceiver 306).

The parasitic loop 412 may be located close to the NFC loop antenna 410 to ensure maximum coupling. The parasitic loop 412 may include a coil of any number of turns and may be sized substantially similar to the NFC coil 422. Stated another way, the parasitic loop 412 may substantially circumscribe the NFC coil 422 to enable strong magnetic coupling between the parasitic loop 412 and the NFC coil 422. By way of example, the parasitic loop 412 may be a coil of one turn.

The parasitic loop 412 may be coupled to a shunt series circuit 424. The shunt series circuit 424 may be used to tune the parasitic loop 412 to specific frequencies, as described below in connection with FIG. 5. The tuned parasitic loop 412 may create a null in the magnetic field of the NFC loop antenna 410 at the frequency of the parasitic loop 412.

One additional benefit of using a parasitic loop 412 is for H-Field shaping. Placing the parasitic loop 412 over an NFC loop antenna 410 may result in reducing the H-Field in the coaxial position and enhancing the H-Field in angles from the coplanar position. This may be a desirable benefit that creates an angled operating volume from the wireless communication device 102 to the listener or polling device, resulting in a more comfortable or fluid motion experienced by the end user.

The use of a parasitic loop 412 can reduce the coaxial antenna pattern at the operating frequency while at the same time enhancing the coplanar antenna pattern. This technique can be used to improve NFC performance for edge mounted antennas, thereby improving the ability of a wireless communication device 102 to read an NFC tag or be read as a tag from the side.

FIG. 5 illustrates one configuration of a parasitic loop 512. The parasitic loop 512 may be included in a wireless communication device 102 configured for inductive communication. For example, the wireless communication device 102 may include an NFC transceiver 306 or an RFID card.

The parasitic loop 512 may include a parasitic coil 526 that is coupled to a shunt series circuit 524. The parasitic coil 526 may be a coil of any number of turns. For example, the parasitic coil 526 may be a coil of one turn.

The shunt series circuit 524 may allow for tuning of the parasitic loop 512. The shunt series circuit 524 may include a first capacitor 528a and a second capacitor 528b and an inductor 530. The first capacitor 528a and the second capacitor 528b may be adjustable (e.g., tunable) capacitors. The first capacitor 528a and the second capacitor 528b may be adjusted to tune the parasitic loop 512 to specific frequencies. For example, the parasitic loop 512 may be tuned to one or more harmonics 114 of a transmit frequency 108 that may interfere with a tuned FM frequency 118.

Although adjustable capacitors 528a,b are shown in FIG. 5, the shunt series circuit 524, may also include switches that add/remove tunable components (such as capacitors and inductors) and/or that open/close the parasitic coil 526, thereby turning the parasitic loop 512 on/off. The shunt series circuit 524 could be implemented on a board, on a chip, or within the NFC transceiver 306.

In one configuration, the tuning of the parasitic loop 512 may be fixed for the specific country of use (e.g., fixed to always tune out harmonics 114 that correspond to the used FM spectrum of a specific country). This may eliminate an additional path between the parasitic loop 512 and other circuitry that could result in coupling of the harmonic 114 through that path. In other words, a fixed parasitic loop 512 tuning may eliminate a path from the FM receiver 104 that may be a source of additional interference.

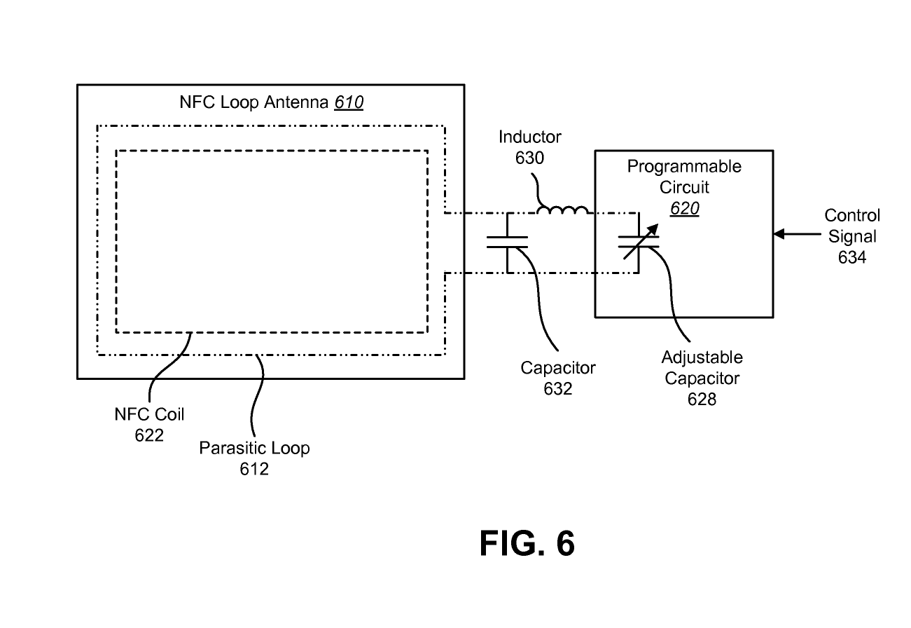

FIG. 6 is a circuit diagram illustrating one configuration of a programmable circuit 620 for a parasitic loop 612. An NFC loop antenna 610 may include an NFC coil 622 and a parasitic loop 612, as described above in connection with FIG. 4. A capacitor 632 and an inductor 630 may be coupled to the parasitic loop 612.

The programmable circuit 620 may be used to tune the parasitic loop 612. In one configuration, the programmable circuit 620 may include an adjustable (e.g., variable) capacitor 628 coupled to the capacitor 632, the inductor 630 and one end of the parasitic loop 612. The programmable circuit 620 may tune the parasitic loop 612 by adjusting the adjustable capacitor 628. In another configuration, the programmable circuit 620 may include one or more switches that add or subtract inductors and/or capacitors to a closed circuit of the parasitic loop 612 to tune the parasitic loop 612.

The current tuned FM frequency 118 may be used to tune the parasitic loop 612. This implies that any programmable switching of the parasitic loop 612 has to be fast enough to avoid an audible artifact in the FM audio. A future FM operating frequency may also be used to pre-tune the parasitic loop 612.

Control of the programmable circuit configuration may be based on one or more control signals 634. In one configuration, the one or more control signals 634 may come from a local NFC transceiver 306 controller. In another configuration, the one or more control signals 634 may be received from any other system on the wireless communication device 102 with knowledge of the current or future tuned FM frequency 118. The one or more control signals 634 may instruct the programmable circuit 620 on how to tune the parasitic loop 612 based on the tuned FM frequency 118. For example, the one or more control signals 634 may indicate an amount to adjust the variable capacitor 628 (or other adjustable components of the programmable circuit 620).

In one configuration, the programmable circuit 620 may be located in an NFC transceiver 306. In another configuration, the programmable circuit 620 may be located in the FM receiver 104 or other system on the wireless communication device 102 with knowledge of the current or future tuned FM frequency 118.

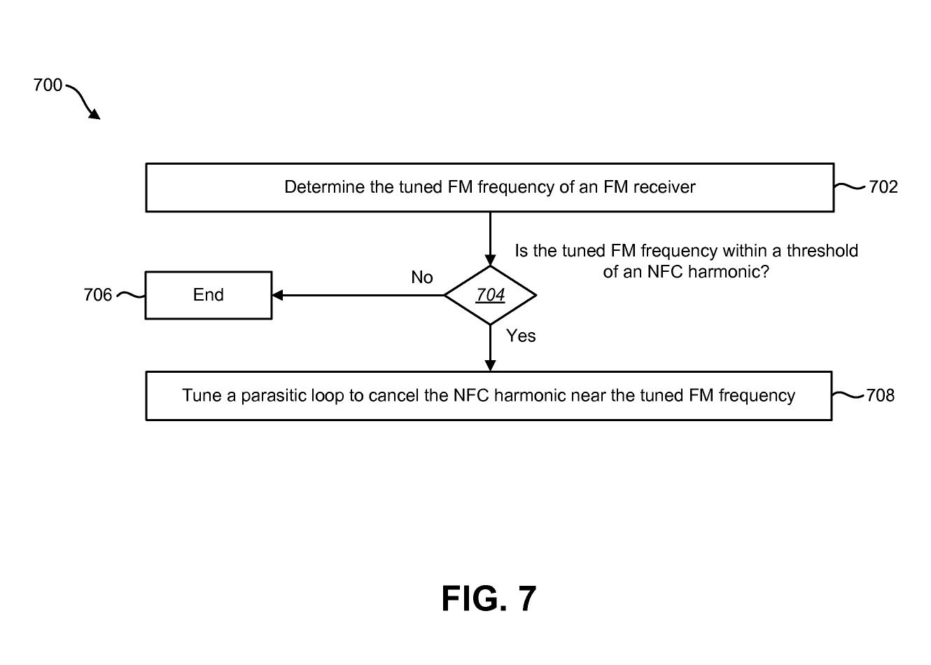

FIG. 7 is a flow diagram of a method 700 for reducing NFC radio interference on FM radios. The method 700 may be performed by a wireless communication device 302. In one configuration, the method 700 may be performed by a controller within an NFC transceiver 306. The method 700 may be performed whenever the NFC transceiver 306 is transmitting. For example, an NFC transceiver 306 may transmit when the wireless communication device 302 is acting as an initiator or a poller and when the wireless communication device 302 is in target mode and a second wireless communication device 302 is transmitting as an initiator or poller.

The wireless communication device 302 may determine 702 the tuned FM frequency 318 of an FM receiver 304. The tuned FM frequency 318 may be a current or future tuned FM frequency 318 (e.g., if the wireless communication device 302 is set to tune to an FM frequency at a specified time). In one configuration, the NFC transceiver 306 may request (e.g., poll) the tuned FM frequency 318 from the FM receiver 304 whenever the NFC transceiver 306 is broadcasting and the FM receiver 304 is turned on. In another configuration, the FM receiver 304 may share the tuned FM frequency 318 with the NFC transceiver 306 whenever the FM receiver 304 is tuned to a frequency near one of the harmonics 314 of the NFC transmit frequency 308.

The wireless communication device 302 may determine 704 whether the tuned FM frequency 318 is within a threshold of an NFC harmonic 314. The threshold may be set based on user experience to ensure no discernible effect on FM receiver 304. For example, the threshold may ensure that audible interference due to an NFC harmonic 314 is canceled. If the tuned FM frequency 318 is not within the threshold of an NFC harmonic 314, then no additional action is needed (since the NFC transmitter is not interfering with the FM receiver) and the method 700 ends 706.

If the wireless communication device 302 determines 704 that the tuned FM frequency 318 is within a threshold of an NFC harmonic 314, the wireless communication device 302 may tune 708 the parasitic loop 312 to cancel the NFC harmonic 314 near the tuned FM frequency 318. Therefore, NFC emissions that interfere with the tuned FM frequency 318 may be canceled. As discussed above, tuning 708 the parasitic loop 312 may include adjusting switches to place components within a closed circuit, adjusting switches to remove components from a closed circuit and adjusting the capacitance of tunable capacitors.

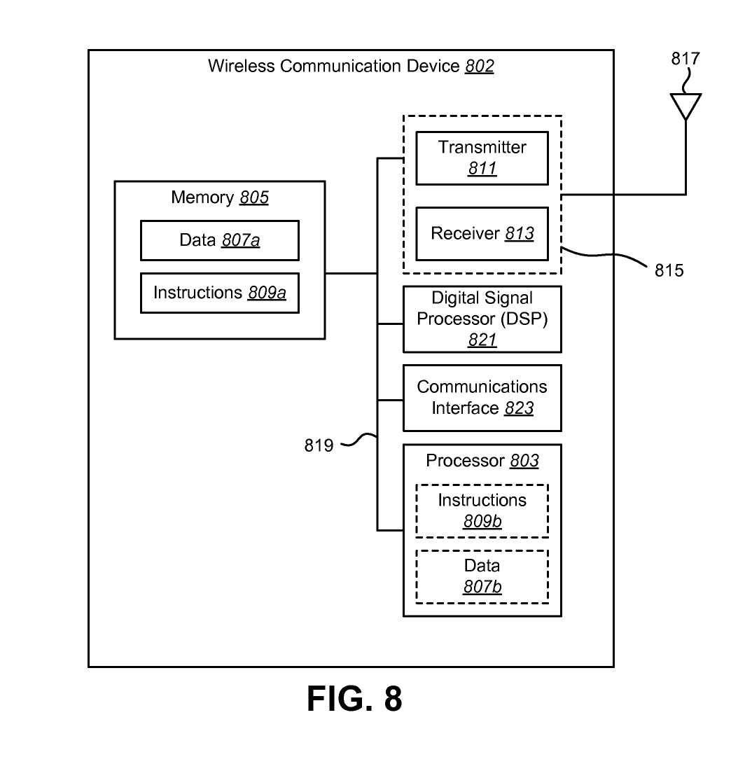

FIG. 8 illustrates certain components that may be included within a wireless communication device 802. The wireless communication device 802 may be an access terminal, a mobile station, a user equipment (UE), etc. For example, the wireless communication device 802 may be the wireless communication device 102 of FIG. 1 or the wireless communication device 302 of FIG. 3.

The wireless communication device 802 includes a processor 803. The processor 803 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 803 may be referred to as a central processing unit (CPU). Although just a single processor 803 is shown in the wireless communication device 802 of FIG. 8, in an alternative configuration, a combination of processors (e.g., an ARM and DSP) could be used.

The wireless communication device 802 also includes memory 805 in electronic communication with the processor (i.e., the processor can read information from and/or write information to the memory). The memory 805 may be any electronic component capable of storing electronic information. The memory 805 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 807a and instructions 809a may be stored in the memory 805. The instructions may include one or more programs, routines, sub-routines, functions, procedures, code, etc. The instructions may include a single computer-readable statement or many computer-readable statements. The instructions 809a may be executable by the processor 803 to implement the methods disclosed herein. Executing the instructions 809a may involve the use of the data 807a that is stored in the memory 805. When the processor 803 executes the instructions 809, various portions of the instructions 809b may be loaded onto the processor 803, and various pieces of data 807b may be loaded onto the processor 803.

The wireless communication device 802 may also include a transmitter 811 and a receiver 813 to allow transmission and reception of signals to and from the wireless communication device 802 via an antenna 817. The transmitter 811 and receiver 813 may be collectively referred to as a transceiver 815. The wireless communication device 802 may also include (not shown) multiple transmitters, multiple antennas, multiple receivers and/or multiple transceivers.

The wireless communication device 802 may include a digital signal processor (DSP) 821. The wireless communication device 802 may also include a communications interface 823. The communications interface 823 may allow a user to interact with the wireless communication device 802.

The various components of the wireless communication device 802 may be coupled together by one or more buses, which may include a power bus, a control signal bus, a status signal bus, a data bus, etc. For the sake of clarity, the various buses are illustrated in FIG. 8 as a bus system 819.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2 and FIG. 7, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for reducing transmission interference, comprising:
determining that a tuned FM frequency of an FM receiver is within a threshold of a harmonic of an inductive communication transmission produced by an inductive communication transceiver, wherein a magnetic field of the inductive communication transceiver is inductively coupled with the FM receiver; and
canceling the harmonic of the inductive communication transmission by energizing a parasitic loop with the magnetic field.

2. The method of claim 1, wherein the parasitic loop is tuned to be an electrical short at the frequency of the harmonic.

3. The method of claim 2, wherein the parasitic loop tuning is fixed based on an FM band of a country of deployment.

4. The method of claim 2, further comprising tuning the parasitic loop to the tuned FM frequency during operation of the FM receiver.

5. The method of claim 2, wherein the parasitic loop is tuned to provide wideband cancelation of multiple harmonics.

6. The method of claim 2, wherein tuning the parasitic loop comprises adjusting one or more tunable capacitors coupled to the parasitic loop.

7. The method of claim 2, wherein tuning the parasitic loop comprises adding or subtracting inductors or capacitors to a closed circuit of the parasitic loop.

8. The method of claim 1, wherein the parasitic loop comprises a coil and a shunt series circuit, wherein the shunt series circuit allows for tuning of the parasitic loop.

9. The method of claim 1 wherein the parasitic loop is located near an inductive communication antenna to ensure strong inductive coupling between the inductive communication antenna and the parasitic loop.

10. The method of claim 1, further comprising activating the parasitic loop when the tuned FM frequency is within the threshold of the harmonic, wherein when the parasitic loop is activated, a null in a magnetic field of an inductive communication antenna is created at the frequency of the parasitic loop.

11. The method of claim 10, wherein when the parasitic loop is activated, there is a short at the harmonic and an open circuit at an operating frequency of an inductive communication transceiver.

12. The method of claim 1, wherein the tuned FM frequency of the FM receiver is proactively shared by the FM receiver.

13. The method of claim 1, wherein the tuned FM frequency of the FM receiver is requested from the FM receiver by a subsystem controlling the parasitic loop.

14. The method of claim 1, wherein the inductive communication transmission is produced by a near-field communication (NFC) transceiver.

15. The method of claim 14, wherein the parasitic loop is used as a secondary NFC antenna when not needed to reduce FM interference.

16. The method of claim 1, wherein the parasitic loop is utilized as a transmitting or a receiving antenna during active load modulation.

17. The method of claim 1, wherein the parasitic loop is placed over an inductive communication antenna to control the direction of an H-field of the inductive communication antenna.

18. An apparatus for reducing transmission interference, comprising:
a processor;
memory in electronic communication with the processor; and
instructions stored in the memory, the instructions being executable by the processor to:
determine that a tuned FM frequency of an FM receiver is within a threshold of a harmonic of an inductive communication transmission produced by an inductive communication transceiver, wherein a magnetic field of the inductive communication transceiver is inductively coupled with the FM receiver; and
cancel the harmonic of the inductive communication transmission by energizing a parasitic loop with the magnetic field.

19. The apparatus of claim 18, wherein the parasitic loop is tuned to be an electrical short at the frequency of the harmonic.

20. A wireless communication device for reducing transmission interference, comprising:
means for determining that a tuned FM frequency of an FM receiver is within a threshold of a harmonic of an inductive communication transmission produced by an inductive communication transceiver, wherein a magnetic field of the inductive communication transceiver is inductively coupled with the FM receiver; and
means for canceling the harmonic of the inductive communication transmission by energizing a parasitic loop with the magnetic field.
